(19) United States
(12) Patent Application Publication
(10) Pub. No.: US 2022/0342684 A1
(43) Pub. Date: Oct. 27, 2022

(54) HARDWARE BASED ABSTRACTION SHARING OF HARDWARE DEVICES ACROSS COMPUTING PLATFORMS

(71) Applicant: INTEL CORPORATION, Santa Clara, CA (US)

(72) Inventors: Mohammad R. Haghighat, San Jose, CA (US); Yong Yao, Cupertino, CA (US); Bin Yang, Shanghai (CN); Ignacio Alvarez, Portland, OR (US); Jia Bao, Shanghai (CN)

(73) Assignee: INTEL CORPORATION, Santa Clara, CA (US)

(21) Appl. No.: 17/057,391

(22) PCT Filed: Dec. 19, 2019
(86) PCT No.: PCT/CN2019/126553

§ 371 Date: Nov. 20, 2020

(51) Int. Cl. G06F 9/455; G06F 9/50

(52) U.S. Cl. CPC G06F 9/45533; G06F 9/5077

(57) ABSTRACT

Method, systems and apparatuses may include technology that identifies a second computing platform that includes a second hardware device that satisfies one or more conditions. The second hardware device is associated with a hardware abstraction layer on the second computing platform. The second computing platform is coupled to a first computing platform. The technology may further include generating a virtual hardware abstraction layer that is to represent the hardware abstraction layer on the second computing platform.

### TECHNICAL FIELD

Embodiments generally relate to sharing of hardware devices across computing platforms (e.g., computing devices). More particularly, embodiments relate to sharing of hardware devices across different computing platforms through virtual hardware abstraction layers (HAL) that are application and device independent to enhance hardware device sharing capabilities, alleviate burdens to applications and enrich product features available to the applications.

### BACKGROUND

Computing platforms may be able to interface with each other in increasingly sophisticated environments. For example, an internet-of-things (TOT) environment (e.g., a smart home and/or a smart city) may include computing platforms that have rich Input/Output (I/O) devices. Some examples of computing platforms include smart sensors, smart audio assistant, smart television, intelligent robots, etc. An IoT computing platform may include hardware devices such as I/O peripheral devices including cameras, microphones, speakers, displays, global positioning system (GPS), and/or advanced sensors that are used to interact with users or environment. It may be difficult if not impossible for IoT computing platforms to leverage other I/O devices of other IoT computing platforms due to incompatibility, software conflicts, burdensome programming and so forth.

### BRIEF DESCRIPTION OF THE DRAWINGS

The various advantages of the embodiments will become apparent to one skilled in the art by reading the following specification and appended claims, and by referencing the following drawings, in which:

FIGS. 1A and 1B illustrate an example of a process of sharing hardware devices across computing platforms according to an embodiment;

FIG. 2 is a flowchart of an example of a method of hardware device sharing according to an embodiment;

FIG. 3 is a flowchart of an example of a method of accessing and utilizing a remote device according to an embodiment;

FIG. 4 is a flowchart of an example of a method of controlled hardware device access according to an embodiment;

FIG. 5 is a flowchart of an example of a method of hardware device access based on security permissions according to an embodiment;

FIG. 6 illustrates an example of a process of sharing hardware devices through a server-based system according to an embodiment;

FIG. 7 illustrates an example of a process of identification and utilization of hardware devices through a decentralized system according to an embodiment;

FIG. 8 is a flowchart of an example of a method of selective encryption of data according to an embodiment;

FIG. 9 is a flowchart of an example of a method of selective compression of data according to an embodiment;

FIG. 10 is a block diagram of an example of a computing system according to an embodiment;

FIG. 11 is an illustration of an example of a semiconductor apparatus according to an embodiment;

FIG. 12 is a block diagram of an example of a processor according to an embodiment; and

FIG. 13 is a block diagram of an example of a multi-processor based computing system according to an embodiment.

### DESCRIPTION OF EMBODIMENTS

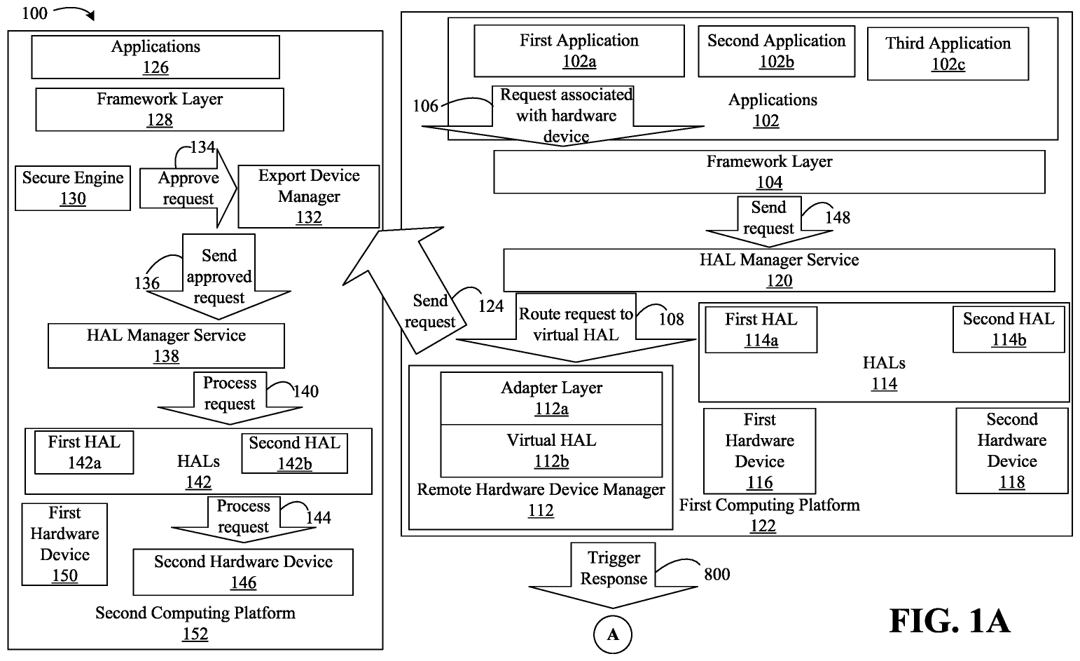

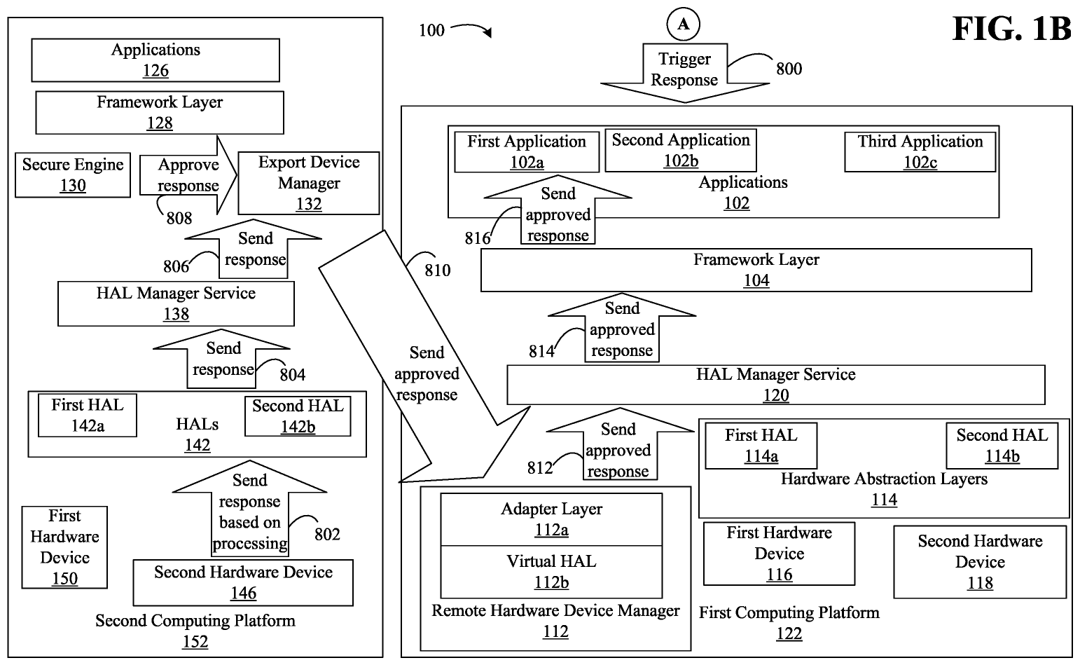

FIGS. 1A and 1B illustrate a process 100 to enhance the sharing of hardware devices (e.g., I/O devices) across first and second computing platforms 122, 152. As will be explained in further detail below, a HAL service architecture may extend across the first and second computing platforms 122, 152. In doing so applications 102, such as first application 102a on the first computing platforms 122, may leverage second hardware device 146 on the second computing platform 152 without burdensome modifications to the applications 102. That is, the first application 102a may be unaware or agnostic to the notion that the second hardware device 146 is on a different platform than the first application 102a. Thus, the first application 102a may execute functions associated with the second hardware device 146 without substantial modifications to the first application 102a to accommodate for the differences in the first and second computing platforms 122, 152. For example, some embodiments may include I/O networking and sharing logic in various modules (e.g., independent modules) to remove modifying either the first application 102a or device specific HAL services resulting in a scheme that is both application independent and device independent.

In doing so, new product features can may be delivered in a unified, efficient and practical manner to the first and second computing platforms 122, 152 to enhance application functionality and enhance a user experience. In contrast, other architectures may attempt to modify an application to interact with hardware devices on remote platforms. Doing so may be burdensome, if not impossible, to implement since new hardware devices and platforms may be added with increasing frequency requiring vast amounts of updates. Moreover, modifying each application separately in a non-unified approach may be inefficient since there may be millions of applications. Further, modifying kernel drivers for devices to provide I/O sharing capabilities may involve complex device dependent modifications that may be impractical to support and implement.

For example, a unified platform for heterogeneous computing, such as ONEAPI technology, may provide an interface to fully exploit various kind of computing resources from a central processing unit (CPU), graphics processing unit (GPU), vision processing unit (VPU), and field-programmable gate array (FPGA) and so on. Some embodiments extend the scope of the platform (e.g., ONEAPI) to support sharing different I/O devices from different computing platforms. Therefore, some embodiments may access the unified platform to enable and utilize hardware device sharing.

FIG. 1A illustrates the first computing platform 122. The first computing platform 122 may be a client computing platform. A client computing platform may use and/or access the hardware devices shared by a service computing platform. The second computing platform 152 may be a service computing platform that executes applications 126. A service computing platform may share hardware devices to other computing platforms. It is worthwhile to note that one computing platform may be both a service platform and a client platform at the same time.

The first and second computing platforms 122, 152 may be joined together to generate an IoT network. In the present example, the first application 102a may send a request associated with a hardware device 106. The request may include an identification of the hardware device (e.g., a type of hardware device and/or a specific functionality that is requested to be executed with a hardware device), an action (e.g., take a picture, store data, provide sensor readings, etc.) to execute with the hardware device and/or whether a response (e.g., send the picture, confirm the data was stored, send the sensor readings, etc.) to the first application 102a is requested.

In this particular example, the hardware device may correspond to the second hardware device 146 of the second computing platform 152. Thus, the request may include an identification of the second hardware device 146. Notably, the first application 102a may be unaware of agnostic to a location of the second hardware device 146 being on the second computing platform 152.

A framework layer 104 may receive the request. The framework layer 104 may be a software used to implement the structure of an application for an operating system. The framework layer 104 may be used to conceal hardware features and provide unified interfaces to application developers. The framework layer 104 may send the request 148 to a HAL manager service 120 that may appropriately route the request. The HAL manager service 120 may manage HALs 114 and virtual HAL 112b. The framework layer 104 may be able to query the HAL manager service 120 to determine which HAL services are available, provide a notification of the available services to the first-third applications 102a-102c and to route requests appropriately.

The HALs 114 may facilitate interaction between an operating system of the first computing platform 122 and first and second hardware devices 116, 118 at a general or abstract level rather than at a detailed hardware level. For example, the operating system of the first computing platform 122 may provide the HALs 114 to decouple framework layer 104 and logic modules for the first and second hardware devices 116, 118. The HALs 114 may include first HAL 114a to interact with the first hardware device 116 and second HAL 114b to interact with the second hardware device 118. Each of the first and second HALs 114a, 114b may be registered with the HAL manager service 120.

The first computing platform 122 may include a remote hardware device manager 112. The remote hardware device manager 112 may manage interactions with remote hardware devices that are not a part of the first computing platform 122. In this particular example, the remote hardware device manager 112 may include an adapter layer 112a and a virtual HAL 112b.

From a perspective of the first computing platform 122, the virtual HAL 112b may represent a second HAL 142b. The second HAL 142b may be associated with the second hardware device 146. The virtual HAL 112b may therefore correspond to the second hardware device 146 of the second computing platform 152. The virtual HAL 112b may decouple the framework layer 104 from underlying hardware and communication mechanisms associated with executing a process with the second hardware device 146. Thus, the virtual HAL 112b may route requests that are for the second hardware device 146. The virtual HAL 112b may be registered with the HAL manager service 120 as well.

As noted above, the HAL manager service 120 may receive the request and route the request appropriately so that the request reaches an appropriate hardware device. As discussed, the request may identify the second hardware device 146. The HAL manager service 120 may identify that the second hardware device 146 is associated with the virtual HAL 112b and route the message accordingly. Thus, the HAL manager service 120 may route the request to the virtual HAL 112b, 108 via the adapter layer 112a.

The adapter layer 112a may receive the request and modify the request if needed. For example, if the operating system of the second computing platform 152 is different from the operating system of the first computing platform 122, the adapter layer 112a may translate data (e.g., instructions) of the request to a format (e.g., language) compatible with the operating system of the second computing platform 152 so that the second computing platform 152 recognizes and processes the data.

The virtual HAL 112b may connect to an export device manager 132 of the second computing platform 152 and route the request accordingly. As already described, the request may be modified by the adapter layer 112a. If the operating system of the first and second computing platforms 122, 152 are the same, the adapter layer 112a may be omitted.

The virtual HAL 112b may send the request 124 to the export device manager 132 of the second computing platform 152. The export device manager 132 may register and manage exportable devices of the second computing platform 152. For example, the second hardware device 146 may be an exportable device that is registered and managed by the export device manager 132. In contrast, the first hardware device 150 may not be an exportable device and therefore may not be managed by the export device manager 132. The export device manager 132 may operate in conjunction with a secure engine 130.

The secure engine 130 may monitor requests and actions of the requests to verify that data sharing is secure and permission-granted. For example, a user and/or operating system of the second computing platform 152 may authorize a set of access permissions (e.g., amount of memory that may be used, data accesses, processing power that may be used, etc.) associated with the second hardware device 146. If any of the actions of the request are deemed to be unauthorized (for example, are not permitted according to the access permissions), the secure engine 130 may deny the one or more actions from being executed.

In this particular example, the secure engine 130 approves the request 134. That is, the secure engine 130 may determine that the request includes actions that are permissible according to the access permissions. In some embodiments, the secure engine 130 may further monitor actions associated with the request that execute in a dedicated virtual machine and/or Software Guard Extensions to verify that the actions (e.g., data sharing) are secure and permission-granted.

The export device manager 132 may send the approved request 136 to HAL manager service 138. The HAL manager service 138 may execute similarly to the HAL manager service 120. The HAL manager service 138 may route the request appropriately to the second HAL 142b.

In detail, the second computing platform 152 may include HALs 142 that includes a first HAL 142a and the second HAL 142b. The first HAL 142a may interact with the first hardware device 150 of the second computing platform 152 and the second HAL 142b may interact with the second hardware device 146. Similar to above, the first and second HALs 142a, 142b may register with the HAL manager service 138 of the second computing platform 152 so that the HAL manager service 138 may route responses appropriately.

a. The second HAL 142b and the second hardware device 146 may process the request 140, 144 (e.g., execute actions of the request). For example, the second HAL 142b may process the request to cause the second hardware device 146 to one or more of configure the second hardware device 146, read data from the second hardware device 146 or write data to the second hardware device 146.

In some embodiments, the second computing platform 152 may access the first hardware device 116 and/or the second hardware device 118 of the first computing platform 122 in order to process the request. For example, suppose that the first application 102a is a game that executes based on a user's movements. The request to the second computing platform 152 may include an instruction to determine the user's movements in real-time. Suppose further that the second computing platform 152 lacks an imaging device or is not positioned to image the user. The second computing platform 152 may query the first computing platform 122 to determine whether the first hardware device 116 and/or the second hardware device 118 is able to image (e.g., includes an imaging functionality) the user, and if so, request access to the first hardware device 116 and/or the second hardware device 118 to obtain images of the user. If the request to the first hardware device 116 and/or the second hardware device 118 is approved, the second computing platform 152 may generate a remote hardware device manager that includes an adapter layer and virtual HAL to control the first hardware device 116 and/or the second hardware device 118. Similarly, the first computing platform 122 may generate an export device manager and secure engine. The second computing platform 152 may then request images of the user from the first hardware device 116 and/or the second hardware device 118 and identify movements of the user from the images. Thus, the first and second computing platforms 122, 152 may establish a bidirectional hardware device sharing scheme.

The processing of the request may trigger a response 800 to the first computing platform 122. In some embodiments, the trigger may be a direct request from the first computing platform 122 to provide a response.

As illustrated in FIG. 1B, the second hardware device 146 may send the response based on the processing 802. The second HAL 142b may send the response 804 to the HAL manager service 138. The HAL manager service 138 may then send the response 806 to the export device manager 132 that may execute in conjunction with the secure engine 130. The secure engine 130 may verify that no sensitive or disapproved data is included in the response. For example, if the user only allows access to a certain set of data (e.g., visual data associated with the camera), other data (e.g., audio data from the camera) may be disapproved by the secure engine 130. For example, the secure engine 130 may compare the data to the access permissions to ensure that no unauthorized data is included in the response. If unauthorized data is included in the response, the response may be modified to remove the unauthorized data or blocked from transmission to the first computing platform 122 altogether.

In this particular example, the secure engine 130 approves the response 808, and so the export device manager 132 sends the approved response 810 to the virtual HAL 112b. The virtual HAL 112b may execute in conjunction with the adapter layer 112a to modify the response. For example, the response may be in a data format compatible with the operating system of the second computing platform 152 but incompatible with the operating system of the first computing platform 122. The adapter layer 112a may modify the response from the incompatible data format to a data format that is compatible with the first computing platform 122. The adapter layer 112a may send the approved response 812 to the HAL manager service 120. The HAL manager service 120 may send the approved response 814 to the framework layer 104. The framework layer 104 may in turn send the approved response 816 to the first application 102a.

The response may include data that the first application 102a may need to execute properly and/or enrich features of the first application 102a. For example, suppose that the first computing platform 122 is a notebook/desktop and the second computing platform 152 is an IOT device at a home of a user of the first computing platform 122. Features of the notebook and/or desktop may be enriched by leveraging the second hardware device 146 (e.g., camera/audio/video) features in the second computing platform 152.

As another example, suppose that the first computing platform 122 is a smart fridge, and the second computing platform 152 is an IoT device that includes a speaker. The first application 102a may orchestrate the first computing platform 122 and the second computing platform 152 to execute functions together. For example, the first computing platform 122 may use the speaker of the second computing platform 152 to inform a user that certain foods are available for upcoming events. For example, the speaker may inform the user that popsicles are available in the freezer for children playing nearby.

Notably, many of the functions described herein may be executed without accessing the cloud since the first computing platform 122 and second computing platform 152 may execute the above functions through a local network. In some embodiments, more than one IoT device may be included to enhance the data sets available. For example, an IoT camera may use image recognition to identify the children and inform the first computing platform 122 that children are present. The first computing platform 122 may then identify which foods are appropriate for children and notify the user of the foods through the second computing platform 152.

In yet another example, some computing platforms lack some special I/O devices. For example, some smart televisions (TVs) may not support touch screen due to cost and efficiency. Thus, users may use remote controllers or voice inputs to control the TVs. Remotes may be difficult to use and may be easily lost. Further, voice input may not be accurate in a noisy environment.

Thus, the first computing platform 122 may be mobile phone, and the second computing platform 152 may be a TV. A touch screen of the first computing platform 122 may be associated with the first application 102a to control the TV, and users may control the TV with the touch screen. For example, the first application 102a may analyze touch inputs, and the first computing platform 122 may inform the second computing platform 152 of the touch inputs to control the second hardware device 146.

As yet another example, some I/O devices may become broken and/or outdated. For example, suppose that the first computing platform 122 is a TV. If a speaker of the first computing platform 122 is broken, a user may consider repairing or replacing the whole first computing platform 122 with a new TV. With speaker sharing, the first application 102a may cause the speaker of the second computing platform 152 (e.g., a smart audio assistant) to play the audio output coming from first computing platform 122 (e.g., the TV).

In some embodiments, each individual hardware feature of the first hardware device 116, the second hardware device 118, the first hardware device 150 and the second hardware device 146 may execute in a dedicated process as a “HAL service” and registers itself to one or more the HAL manager services 120, 138. The framework layers 104, 128 may access a specific HAL service, such as first HAL 142a, second HAL 142b, first HAL 114a, second HAL 114b, through querying the HAL manager services 120, 138.

In some embodiments, the HAL manager service 138 may register the exportable devices of the second computing platform 152 to the export device manager 132. Thus, every exported service of the second computing platform 152 registers itself to export device manager 132. Therefore, the second hardware device 146 may register itself with the export device manager 132. The export device manager 132 may respond to any inquiries from any other computing platforms so that the other computing platforms may identify the exported services offered by the second computing platform 152. The export device manager 132 may include a data structure that includes data for each exported device. Table I below shows one such example of the data structure:

TABLE I

| | | |
|---|---|---|
| Identification for exported | Permission requirement | Status |
| device | | |

In some embodiments, the first computing platform 122 may obtain the address of the second computing platform 152 through static configurations (e.g., configured through a configuration tool) and/or a dynamic configuration (e.g., through a service discovery protocol such as Universal Plug and Play).

A user of the first computing platform 122 may execute actions that are normally executable for a local device HAL. In some embodiments, a user of the second computing platform 152 may need to provide permission to allow usage of the second hardware device 146 before the first computing platform 122 is allowed to access the second hardware device 146. In some embodiments, the data sharing between the first and second computing platforms 122, 152 may be compressed if a size of the data is above a size threshold and uncompressed if the size is below the size threshold. Furthermore, the data may be encrypted in some embodiments when sensitive data is being shared.

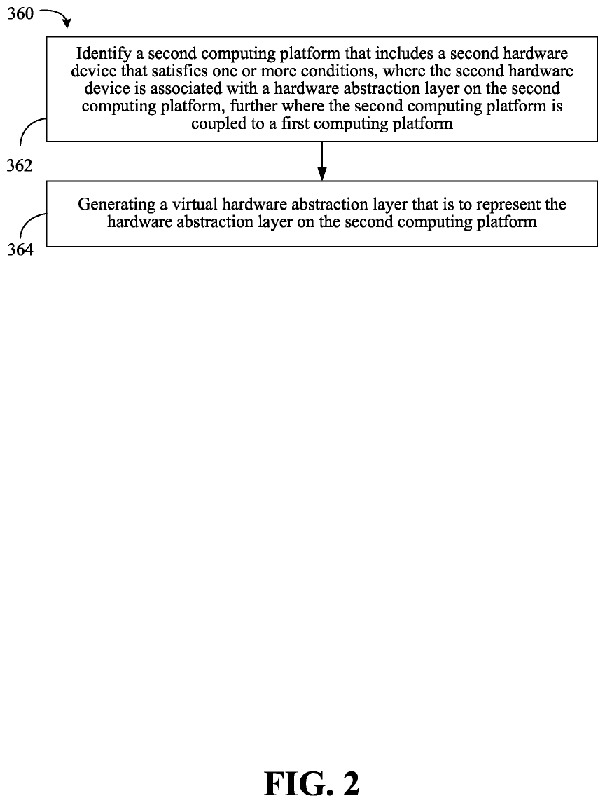

FIG. 2 shows a method 360 that may provide enhanced hardware device sharing. The method 360 may generally be implemented by first and second computing platforms 122, 152 (FIG. 1) and operate in conjunction with any of the embodiments described herein, such as, for example the process 100 (FIG. 1), already discussed. In an embodiment, the method 360 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 360 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 362 identifies a second computing platform that includes a second hardware device that satisfies one or more conditions. The second hardware device is associated with a hardware abstraction layer on the second computing platform. The second computing platform is coupled to a first computing platform. Illustrated processing block 364 generates a virtual hardware abstraction layer that represents the hardware abstraction layer on the second computing platform.

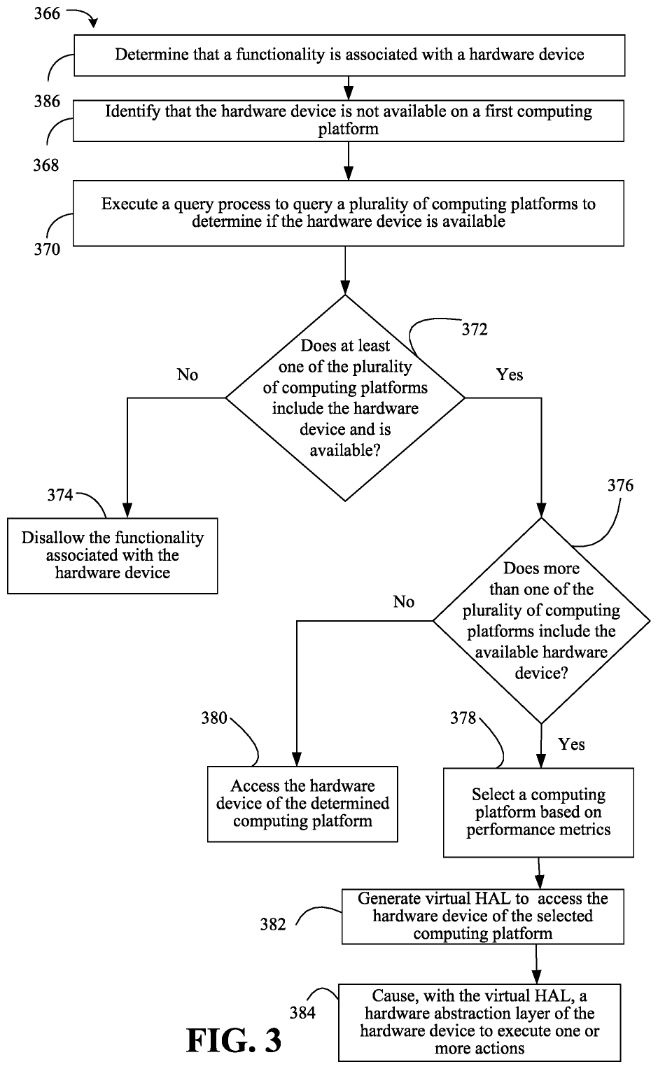

FIG. 3 illustrates a method 366 to access and utilize a remote device. The method 366 may generally be implemented in conjunction with any of the embodiments described herein, such as, for example the process 100 (FIGS. 1A and 1B) and the method 360 (FIG. 2) already discussed. More particularly, the method 366 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 386 determines that a functionality is associated with a hardware device. The functionality may enhance an application on a first computing platform for example. Illustrated processing block 368 identifies that the hardware device is not available (e.g., hardware doesn't exist, desired functionality and/or desired quality of functionality doesn't exist on the first computing platform) on the first computing platform. Illustrated processing block 368 may be executed by the first computing platform. Illustrated processing block 370 executes a query process to query a plurality of computing platforms to determine if the hardware device is available. Processing block 370 may be executed by the first computing platform. In some embodiments, processing block 370 includes executing a query process to query a plurality of export device managers of a plurality of computing platforms. For example, the first computing platform may query all computing platforms within a predetermined range. Further, each of the plurality of computing platforms may include an export device manager that may be queried by the first computing platform and may respond to the first computing platform through a response.

Illustrated processing block 372 determines if at least one of the plurality of computing platforms include the hardware device and is available. For example, the query above may inquire whether any of the plurality of computing platforms includes the hardware device and/or if the hardware device is available. Each of the responses may indicate whether a computing platform, that originates the response, includes the hardware device and/or if the hardware device is available. If none of the plurality of computing platforms includes the hardware device and/or the hardware device is present but unavailable, illustrated processing block 374 disallows the functionality associated with the hardware device.

If at least one of the plurality of computing platforms includes the hardware device and the hardware device is available, illustrated processing block 376 determines whether more than one of the plurality of computing platforms includes the available hardware device. If not, illustrated processing block 380 accesses the available hardware device of the determined computing platform (e.g., the one computing platform that includes the available hardware device).

Otherwise, illustrated processing block 378 selects a computing platform of the plurality of computing platforms based on performance metrics. That is, if two or more of the computing devices each include an available hardware device, processing block 378 selects one of the two or more computing devices based on performance metrics. In some embodiments, the performance metrics may include bandwidth analysis, latency analysis, version analysis and so on. For example, if one computing platform includes a latest version of the hardware device, the first computing platform may select the one computing platform. Similarly, the first computing platform may also consider bandwidth, processing power and latency of the computing platforms to select a most efficient computing platform.

Illustrated processing block 382 generates, at the first computing platform, a virtual HAL to access the hardware device of the selected computing platform. Illustrated processing block 384 causes, with the virtual HAL of the first computing platform, a hardware abstraction layer of the hardware device to execute one or more actions on behalf of the first computing platform.

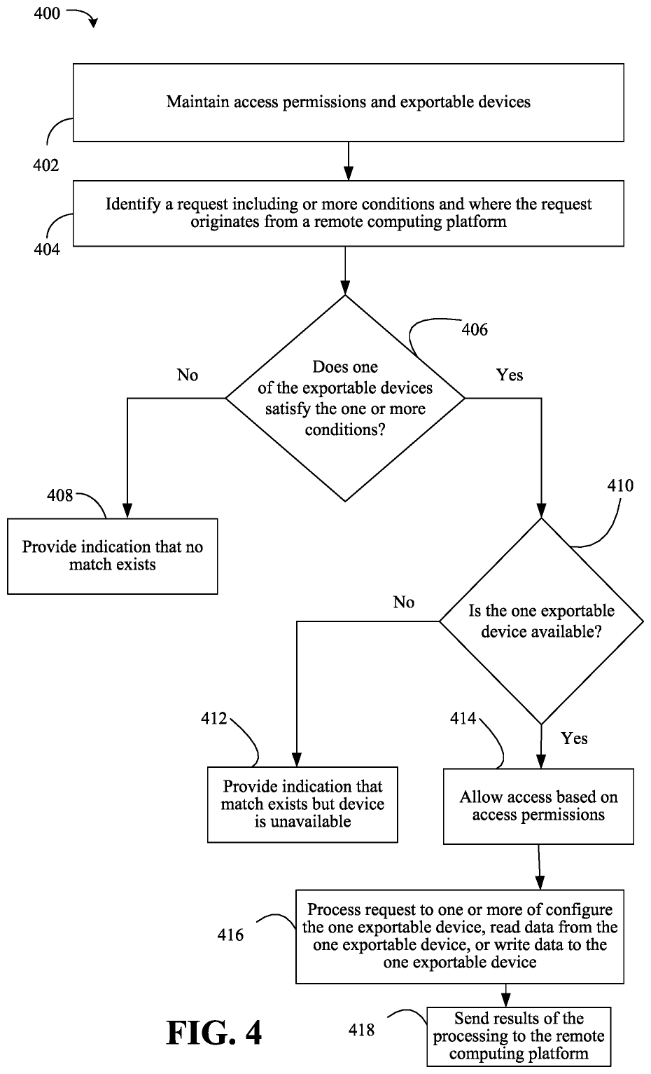

FIG. 4 illustrates a method 400 of controlled hardware device access. The method 400 may generally be implemented in conjunction with any of the embodiments described herein, such as, for example the process 100 (FIGS. 1A and 1B), the method 360 (FIG. 2) and the method 366 (FIG. 3) already discussed. More particularly, the method 400 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 402 maintains access permissions and exportable devices (e.g., maintain a data structure that identifies the access permission and exportable devices). Illustrated processing block 402 may be implemented by a computing platform and in particular may be implemented by a secure engine and/or an export device manager. The exportable devices may be hardware devices that are a part of the computing platform. A user and/or operating system may set access permissions to access the exportable devices.

Illustrated processing block 404 identifies a request including or more conditions and where the request originates from a remote computing platform. Illustrated processing block 406 determines if one of the exportable devices satisfies the one or more conditions. For example, the request may include one or more conditions that are to be satisfied by the exportable device. For example, one of the conditions may include that the first device should be a specific hardware device (e.g., camera) and/or include a specific functionality. If any of the exportable devices are a camera and/or include the specific functionality, a match may be found (the condition is satisfied). In some embodiments, processing block 406 may determine whether any of the exportable devices encompasses the first device. In some embodiments, processing block 406 may also include identifying parameter conditions (e.g., bandwidth thresholds, processing power thresholds, fidelity thresholds, quality thresholds) from the request and determining whether any of the exportable devices meets the parameter conditions. If so, the one exportable device that meets the parameter conditions may match the first device.

If none of the exportable devices satisfy the one or more conditions, illustrated processing block 408 may provide an indication that no match exists to the remote computing platform. Otherwise, illustrated processing block 410 determines whether the one exportable device is available. For example, the one exportable device may satisfy the one or more conditions, but already be committed to another computing platform or process. In such a case, the one exportable device is not available, and illustrated processing block 412 provides an indication that the match exists but the device is unavailable. The indication may be transmitted to the remote computing platform. The remote computing platform may therefore be aware that a match exists, and periodically interrogate the computing platform to determine whether the one exportable device is available. In some embodiments, the indication may include an estimate of when the one exportable device will be available so that the remote computing platform may determine a time to interrogate the computing platform.

If the one exportable device is available, illustrated processing block 414 allows access based on the access permission of the one exportable device. For example, if an action, that is requested from the remote computing platform, does not correspond to the access permissions, processing block 414 may disallow the action.

Illustrated processing block 416 processes requests from the remote computing platform to one or more of configure the one exportable device (based on the request), read data from the one exportable device (based on the request), or write data to the one exportable device (based on the request). Illustrated processing block 418 may send results of the processing to the remote computing platform.

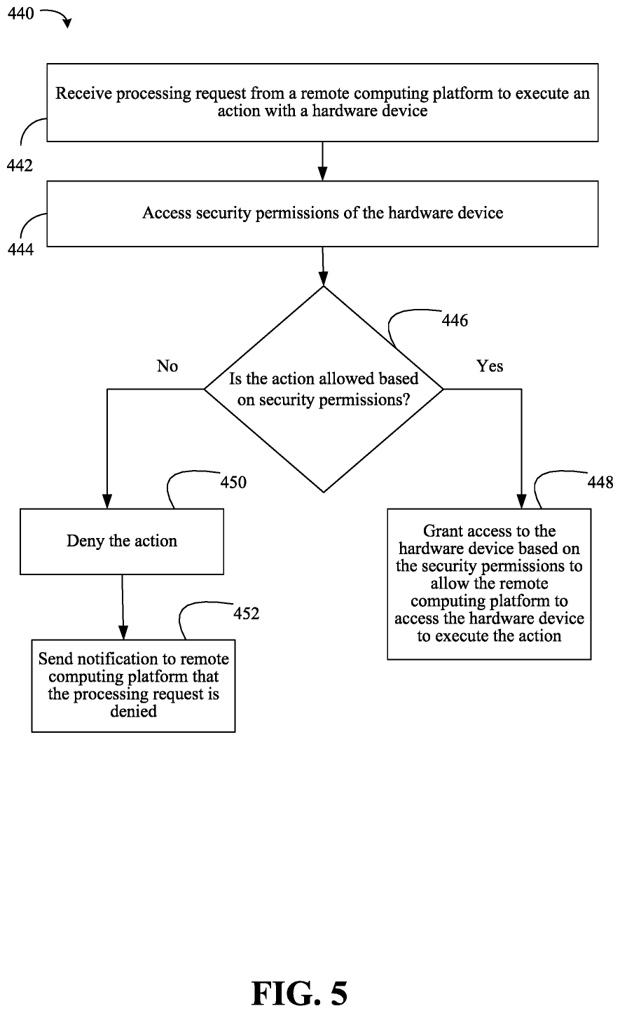

FIG. 5 illustrates a method 440 of hardware device access based on security permissions. The method 440 may generally be implemented in conjunction with any of the embodiments described herein, such as, for example the process 100 (FIGS. 1A and 1B), the method 360 (FIG. 2), the method 366 (FIG. 3) and/or the method 400 (FIG. 4) already discussed. More particularly, the method 440 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof. The method 440 may be implemented by a computing platform that is connected to the remote computing platform.

Illustrated processing block 442 receives a processing request from the remote computing platform to execute an action with a hardware device. The processing request may include an instruction to execute the action with the hardware device. The hardware device may be part of the computing platform. Illustrated processing block 444 accesses security permissions (e.g., access permissions) of the hardware device. Illustrated processing block 446 determines whether the action is allowed based on the security permissions. For example, if the security permissions indicate that only some types of data accesses are allowed, processing block 446 may check whether the action will access the types of data. If not, illustrated processing block 450 may deny the action and illustrated processing block 452 sends a notification to the remote computing platform that the processing request (and action) is denied.

If illustrated processing block 446 determines that the action is allowed based on the security permissions, illustrated processing block 448 grants access to the hardware device based on the security permissions to allow the remote computing platform to access the hardware device to execute the action. Thus, the computing platform may allow the remote computing platform to access the hardware device.

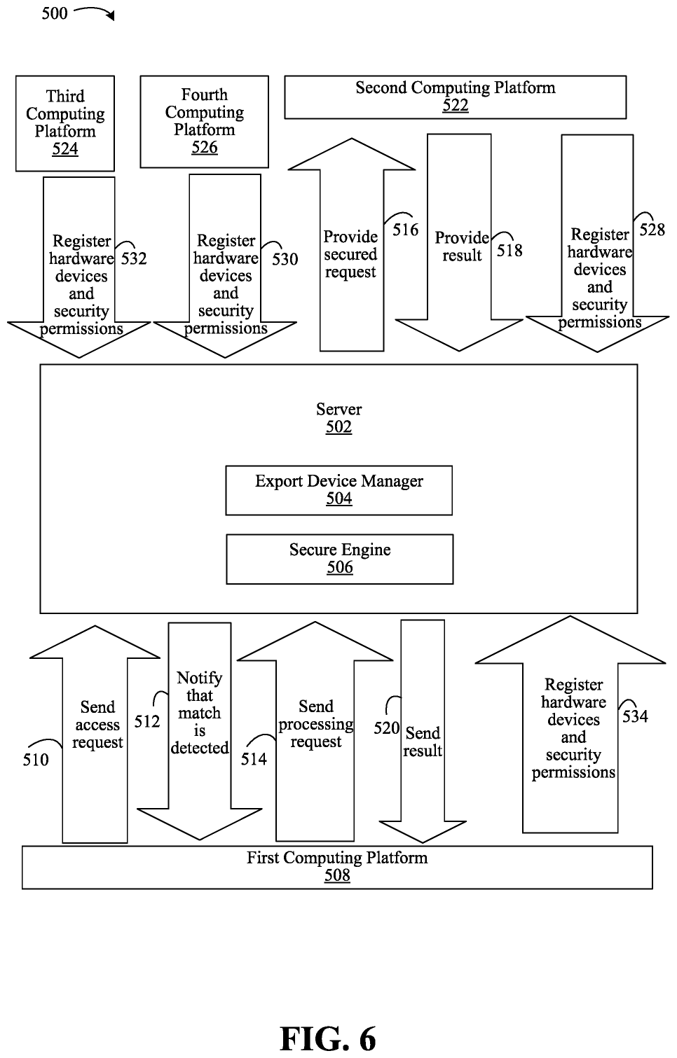

FIG. 6 illustrates a process 500 to enhance the sharing of hardware devices (e.g., I/O devices) through a server-based system. The process 500 may generally be implemented in conjunction with any of the embodiments described herein, such as, for example the process 100 (FIGS. 1A and 1B), the method 360 (FIG. 2), the method 366 (FIG. 3), the method 400 (FIG. 4) and/or the method 440 (FIG. 5) already discussed. As illustrated, the process 500 may include a server 502. The server 502 may control the identification and exportation of hardware devices. The server 502 may include an export device manager 504 and a secure engine 506. As illustrated, a first computing platform 508, second computing platform 522, third computing platform 524 and fourth computing platform 526 are each communicably connected to the server 502. The first computing platform 508 may register hardware devices and security permissions 534. The security permissions (e.g., access permissions) may correspond to the hardware devices. The hardware devices may be registered with the export device manager 504, and the security permissions may be stored in the secure engine 506.

Similarly, the second computing platform 522 may register hardware devices and security permissions 528 with the server 502. The hardware devices may be stored as exportable devices in the export device manager 504 and the security permissions (e.g., access permissions) may be stored as part of the secure engine 506.

Likewise, the third computing platform 524 may register hardware devices and security permissions 532 with the server 502. The hardware devices may be stored as exportable devices in the export device manager 504 and the security permissions (e.g., access permissions) may be stored as part of the secure engine 506.

Similar to the above, the fourth computing platform 526 may register hardware devices and security permissions 530 with the server 502. The hardware devices may be stored as exportable devices in the export device manager 504 and the security permissions (e.g., access permissions) may be stored as part of the secure engine 506.

The first computing platform 508 may send an access request 510 to the server 502. The access request may include an identification of a hardware device that the first computing platform 508 will utilize. The server 502 may access the export device manager 504 and determine a match from the registered hardware devices. In the present example, the server 502 may determine that the second computing platform 522 includes the hardware device. The server 502 may notify the first computing platform 508 that a match is detected 512. The notification may include an address and/or other identifier that the first computing platform 508 is to use to address data to the hardware device of the second computing platform 522.

The first computing platform 508 may send a processing request 514 to the server 502. The processing request may include the identifier or the address so that the server 502 may identify an appropriate routing system for the processing request. The processing request may also include an action that is to be executed with the hardware device. The server 502 may verify that the action is permitted by checking the action against the security permissions of the hardware device, and then provide the secured request 516 to the second computing platform 522. Similar to as above, the server 502 may disallow any unauthorized actions that do not comport with the security permissions.

The second computing platform 522 may process the request and provide a result 518 of the processing request to the server 502. The server 502 may in turn send the result 520 to the first computing platform 508. Thus, the server 502 may control the data flows between the first, second, third and fourth computing platforms 508, 522, 524, 526.

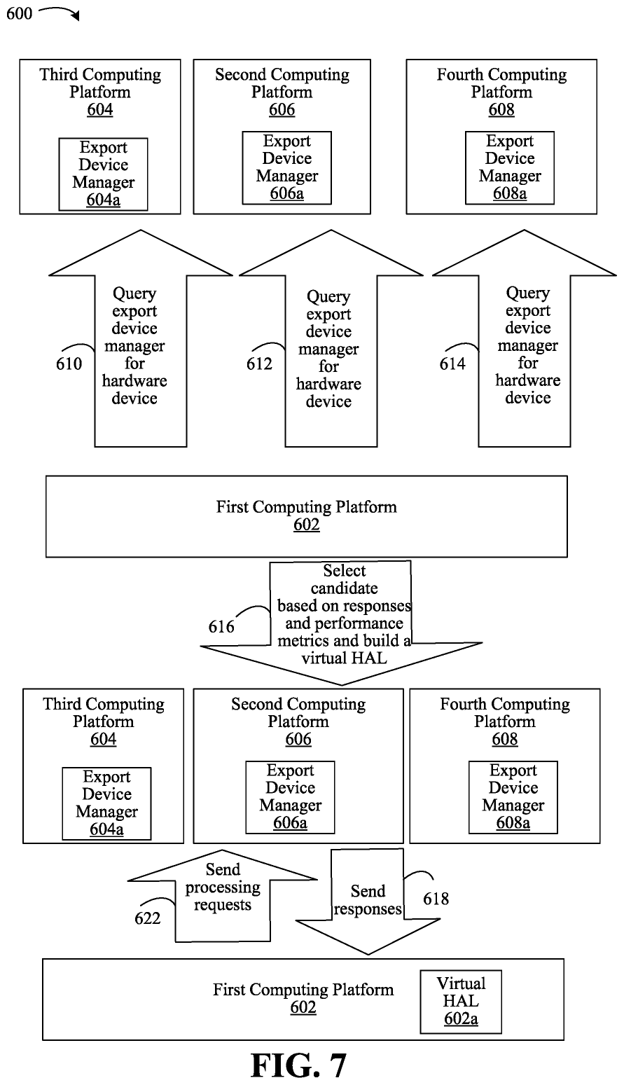

FIG. 7 illustrates a process 600 to enhance the identification and utilization of hardware devices (e.g., I/O devices) through a decentralized system. The process 600 may generally be implemented in conjunction with any of the embodiments described herein, such as, for example the process 100 (FIGS. 1A and 1B), the method 360 (FIG. 2), the method 366 (FIG. 3), the method 400 (FIG. 4) and/or the method 440 (FIG. 5) already discussed. In detail, the first computing platform 602 may determine that a hardware device is to be utilized. The first computing platform 602 may determine that the hardware device is not present and/or unavailable on the first computing platform 602 and query a second computing platform 606, a third computing platform 604 and a fourth computing platform 608 for the hardware device.

In detail, the first computing platform 602 may query an export device manager 606a for the hardware device 612, query an export device manager 604a for the hardware device 610 and query an export device manager 608a for the hardware device 614. The first computing platform 602 may select a candidate based on responses to the queries and performance metrics and build a virtual HAL 602a, 616.

In this particular example, the export device manager 606a of the second computing platform 606 may indicate that the hardware device is available and present on the second computing platform 606 (e.g., meets conditions for exportation). The first computing platform 602 may determine that the hardware device on the second computing platform 606 meets the performance metrics (e.g., available, has a certain processing power, is positioned to accurately retrieve sensor data, etc.). The virtual HAL 602a may be built to represent a HAL of the second computing platform 606 that controls the hardware device. The first computing platform 602 may send processing requests 622 to the second computing platform 606 via the virtual HAL 602a. The second computing platform 606 may send responses 618 to the first computing platform 602.

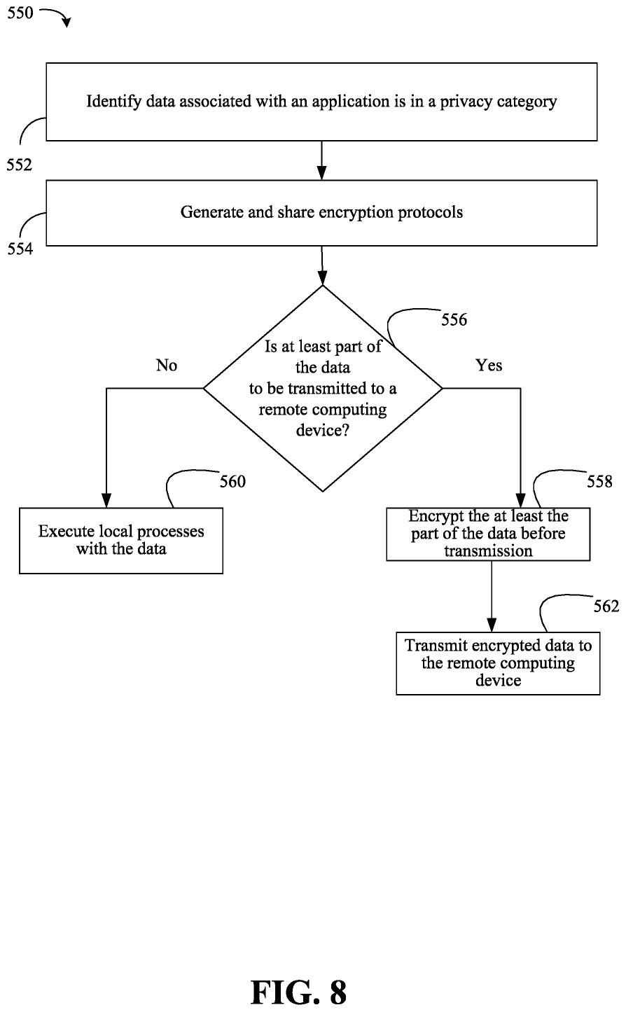

FIG. 8 illustrates a method 550 of selective encryption of data to be transmitted to a remote hardware device. The method 550 may generally be implemented in conjunction with any of the embodiments described herein, such as, for example the process 100 (FIGS. 1A and 1B), the method 360 (FIG. 2), the method 366 (FIG. 3), the method 400 (FIG. 4), the method 440 (FIG. 5), the process 500 (FIG. 6) and/or the process 600 (FIG. 7) already discussed. More particularly, the method 550 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof. The method 550 may be implemented by a computing platform that is connected to a remote computing platform.

Illustrated processing block 552 identifies that data associated with an application is in a privacy category. For example, the application may utilize data that is confidential (e.g., social security numbers, medical history, personal pictures, etc.). Illustrated processing block 554 generates and shares encryption protocols between computing platforms. For example, a first of the computing platforms may execute the application and a second of the computing platforms (e.g., a remote computing platform) may include a hardware device to process the data. Illustrated processing block 556 determines if at least part of the data is to be transmitted to a remote computing device, such as the second computing platform. If so, illustrated processing block 558 may encrypt the at least the part of the data before transmission and illustrated processing block 562 transmits the encrypted data to the remote computing device. While not illustrated, the remote computing device may decrypt the data with the shared encryption protocols.

Otherwise, illustrated processing block 560 may execute local processes with the data. Illustrated processing block 560 may not necessarily include encrypting the data.

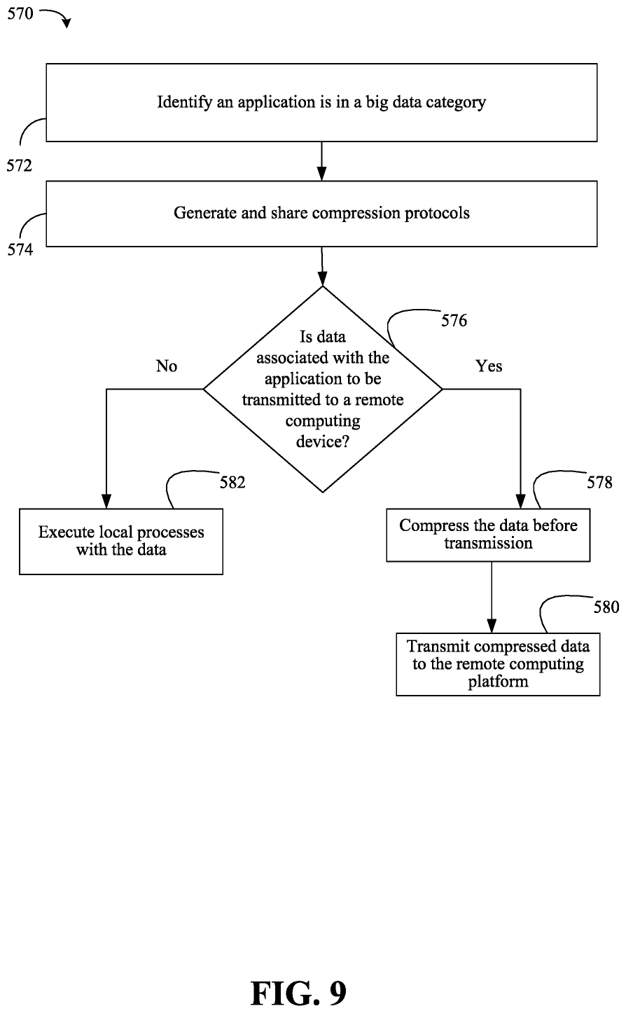

FIG. 9 illustrates a method 570 of selective compression of data to be transmitted to a remote hardware device. The method 570 may generally be implemented in conjunction with any of the embodiments described herein, such as, for example the process 100 (FIGS. 1A and 1B), the method 360 (FIG. 2), the method 366 (FIG. 3), the method 400 (FIG. 4), the method 440 (FIG. 5), the process 500 (FIG. 6), the process 600 (FIG. 7) and/or the method 550 (FIG. 8) already discussed. More particularly, the method 570 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof. The method 570 may be implemented by a computing platform that is connected to the remote computing platform.

Illustrated processing block 572 identifies that an application is in a big data category. Illustrated processing block 574 generates and shares compression protocols with the computing platform and the remote computing platform. Illustrated processing block 576 determines if data associated with the application is to be transmitted to the remote computing device. If so, illustrated processing block 578 compresses the data before transmission. Illustrated processing block 580 transmits the compressed data to the remote computing platform. While not illustrated, the remote computing platform may decompress the data. Otherwise, illustrated processing block 582 executes local processes with the data on the computing platform. Processing block 582 may leave the data uncompressed.

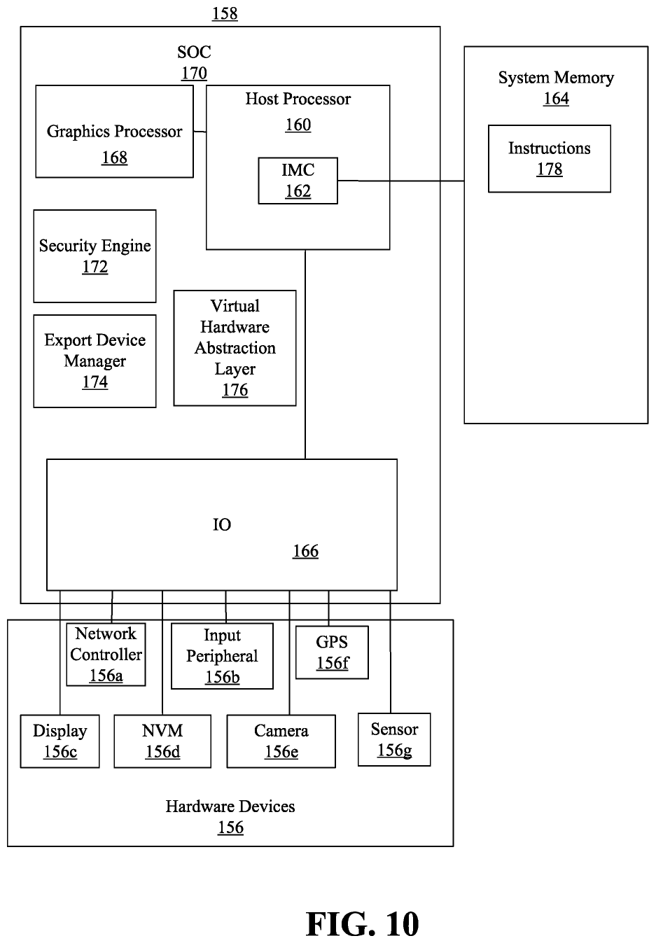

Turning now to FIG. 10, a hardware enhanced computing system 158 (e.g., server, computing device, computing platform and/or node) is shown. The computing system 158 is combinable with any of the embodiments described herein, such as, the process 100 (FIGS. 1A and 1B), the method 360 (FIG. 2), the method 366 (FIG. 3), the method 400 (FIG. 4), the method 440 (FIG. 5), the process 500 (FIG. 6), the process 600 (FIG. 7), the method 550 (FIG. 8) and/or the method 570 (FIG. 9) already discussed. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), etc., IoT functionality or any combination thereof. In the illustrated example, the system 158 includes a host processor 160 (e.g., CPU with one or more processor cores) having an integrated memory controller (IMC) 162 that is coupled to a system memory 164.

The illustrated system 158 also includes a graphics processor 168 (e.g., graphics processing unit/GPU) and an input output (IO) module 166 implemented together with the host processor 160 (e.g., as microcontrollers) on a semiconductor die 170 as a system on chip (SOC), where the IO module 166 may communicate with, hardware devices 156 that include for example, a display 156c (e.g., touch screen, liquid crystal display/LCD, light emitting diode/LED display), an input peripheral 156b (e.g., mouse, keyboard, microphone), a network controller 156a (e.g., wired and/or wireless), and a non-volatile memory (NVM) 156d (e.g., a mass storage such as an hard disk drive (HDD), optical disc, solid-state drive (SSD), flash memory or other NVM). The hardware devices 156 may also include a camera 156e, GPS 156f and sensor 156g. Any of the hardware devices 156 may an exportable device that is registered to the export device manager 174.

In some embodiments, the SoC 170 may include a security engine 172 to verify that any remotely requested actions associated with the hardware devices 156 conform to an established security policy of the system 158. The security engine 172 may enforce the security policy. Thus, the computing system 158 may be considered performance-enhanced to the extent that the computing system 158 may enhance security, omit sensitive ones of the hardware devices 156 from being shared and/or protect sensitive user data.

The host processor 160 may communicate with a remote computing device (e.g., computing platform such as an IoT device) via the network controller 156a. The computing system 158 may provide data to other computing devices through the network controller 156a. For example, the virtual hardware abstraction layer 176 may cause an action to be executed on a hardware device of the remote computing device on behalf of an application executing on the system 158. Thus, the computing system 158 may be considered performance-enhanced to the extent that hardware devices from other computing platforms may be utilized to enhance, enrich and provide additional functionality to the architecture of the system 158. In some embodiments, the instructions 178 when executed by one or more of the host processor 160 or the graphics processor 168 may cause one or more an application, the virtual hardware abstraction layer 176, security engine 172 or export device manager 174 to execute.

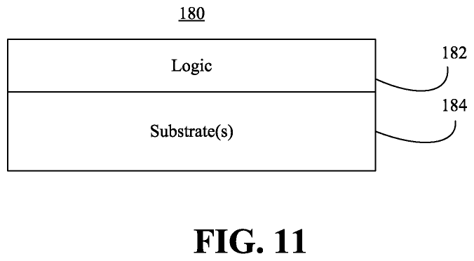

FIG. 11 shows a semiconductor package apparatus 180. The illustrated apparatus 180 includes one or more substrates 184 (e.g., silicon, sapphire, gallium arsenide) and logic 182 (e.g., transistor array and other integrated circuit/IC components) coupled to the substrate(s) 184. In one example, the logic 182 is implemented at least partly in configurable logic or fixed-functionality logic hardware. The logic 182 may implement one or more aspects of the process 100 (FIGS. 1A and 1B), the method 360 (FIG. 2), the method 366 (FIG. 3), the method 400 (FIG. 4), the method 440 (FIG. 5), the process 500 (FIG. 6), the process 600 (FIG. 7), the method 550 (FIG. 8), the method 570 (FIG. 9) and/or the computing system 158 (FIG. 10) already discussed.

In some embodiments, the logic 182 may be part of a first computing platform coupled to a first computing platform. The logic 182 may identify a second computing platform that includes a second hardware device that satisfies one or more conditions. The second hardware device may be associated with a hardware abstraction layer on the second computing platform. The logic 182 may further generate a virtual hardware abstraction layer that is to represent the hardware abstraction layer on the second computing platform. The logic 182 may cause, with the virtual hardware abstraction layer, the hardware abstraction layer associated with the second hardware device to execute one or more actions. In some embodiments, the one or more actions are to be associated with an application on the first computing platform. Thus, in some embodiments, the apparatus 180 may be considered performance-enhanced to the extent that the apparatus 180 may leverage hardware devices of other computing platforms to enhance the functionality of the apparatus 180 and/or the first computing platform, to enhance efficiency of the apparatus 180 and/or the first computing platform and provide applications with a rich selection of hardware devices to utilize.

In some embodiments, the logic 182 may further identify a request from a third computing platform to access a first hardware device of the first computing platform. In response to the request, the logic 182 may grant access to the first hardware device based on one or more access permissions to allow the third computing platform to access the first hardware device. The logic 182 may also monitor requests for actions from the third computing platform to identify whether the actions are permitted according to the one or more access permissions. The actions may be associated with the first hardware device. The logic 182 may deny one or more of the actions that are determined to be impermissible according to the one or more access permissions. Thus, the apparatus 180 may be security-enhanced to the extent that the apparatus 180 disallows actions that may comprise user data and/or devices, enforces security policies and protect sensitive user data.

In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

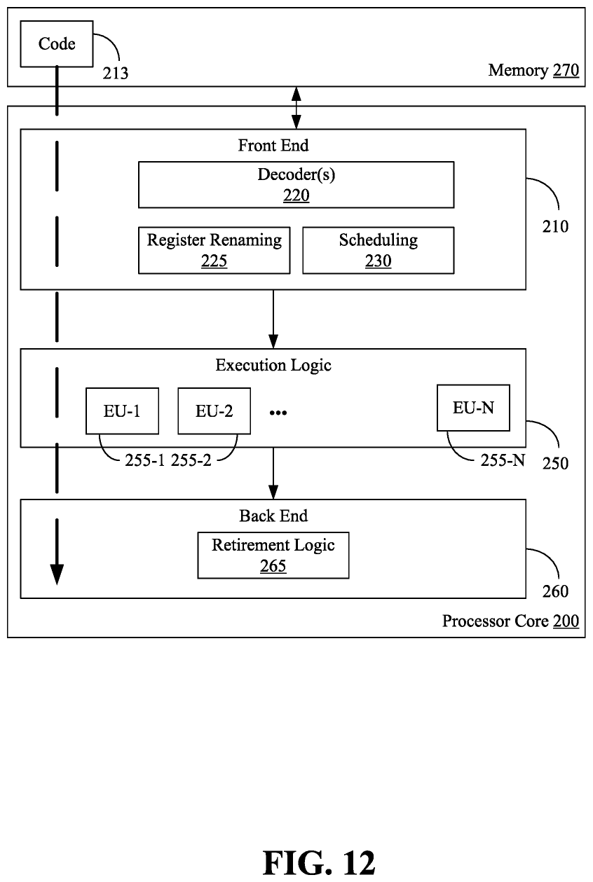

FIG. 12 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 12, a processing element may alternatively include more than one of the processor core 200 illustrated in FIG. 12. The processor core 200 may be a single-threaded core or, for at least one embodiment, the processor core 200 may be multithreaded in that it may include more than one hardware thread context (or “logical processor”) per core.

FIG. 12 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of process 100 (FIGS. 1A and 1B), the method 360 (FIG. 2), the method 366 (FIG. 3), the method 400 (FIG. 4), the method 440 (FIG. 5), the process 500 (FIG. 6), the process 600 (FIG. 7), the method 550 (FIG. 8), the method 570 (FIG. 9) and/or the computing system 158 (FIG. 10) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 12, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

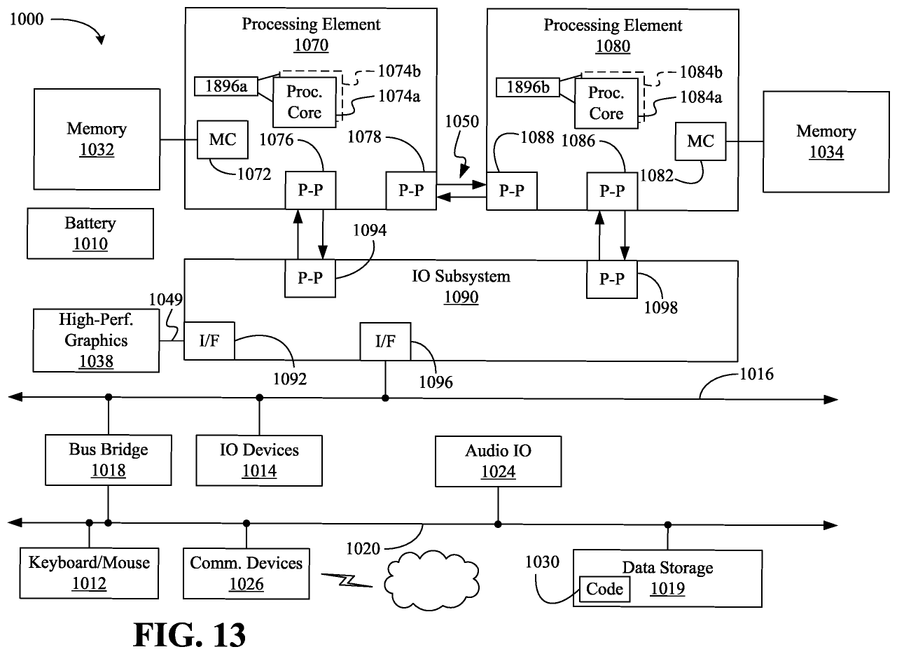

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of the first and second processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each of the first and second processing elements 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two first and second processing elements 1070, 1080, it is to be understood that the scope of the embodiments are not so limited. In other embodiments, one or more additional processing elements may be present in a given processor. Alternatively, one or more of the first and second processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the first and second processing elements 1070, 1080 in terms of a spectrum of metrics of merit including architectural, micro architectural, thermal, power consumption characteristics, and the like. These differences may effectively manifest themselves as asymmetry and heterogeneity amongst the first and second processing elements 1070, 1080. For at least one embodiment, the various first and second processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the first and second processing elements 1070, 1080, for alternative embodiments the MC logic may be discrete logic outside the first and second processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the process 100 (FIGS. 1A and 1B), the method 360 (FIG. 2), the method 366 (FIG. 3), the method 400 (FIG. 4), the method 440 (FIG. 5), the process 500 (FIG. 6), the process 600 (FIG. 7), the method 550 (FIG. 8), the method 570 (FIG. 9) and/or the computing system 158 (FIG. 10) already discussed. Further, an audio I/O 1024 may be coupled to second bus 1020 and a battery 1010 may supply power to the computing system 1000.

Note that other embodiments are contemplated. For example, instead of the point-to-point architecture of FIG. 13 a system may implement a multi-drop bus or another such communication topology. Also, the elements of FIG. 13 may alternatively be partitioned using more or fewer integrated chips than shown in FIG. 13.

### ADDITIONAL NOTES AND EXAMPLES

Example 1 includes a first computing platform comprising a first hardware device, a graphics processor, a central processing unit, and a memory including a set of instructions, which when executed by one or more of the graphics processor or the central processing unit, cause the first computing platform to identify a second computing platform that is to include a second hardware device that is to satisfy one or more conditions, wherein the second hardware device is to be associated with a hardware abstraction layer on the second computing platform, and generate a virtual hardware abstraction layer that is to represent the hardware abstraction layer on the second computing platform.

Example 2 includes the first computing platform of Example 1, wherein the instructions, when executed, cause the first computing platform to conduct an identification that the first hardware device is to fail to satisfy the one or more conditions, wherein the one or more conditions are to include a functionality, in response to the identification, cause a query process to query a plurality of computing platforms to identify whether the plurality of computing platforms includes hardware devices that each satisfy the one or more conditions, wherein the plurality of computing platforms is to include the second computing platform, and identify the second hardware device based on responses by the plurality of computing platforms to the query process.

Example 3 includes the first computing platform of Example 1, wherein the instructions, when executed, cause the first computing platform to cause, with the virtual hardware abstraction layer, the hardware abstraction layer associated with the second hardware device to execute one or more actions, wherein the one or more actions are to be associated with an application on the first computing platform.

Example 4 includes the first computing platform of Example 1, wherein the instructions, when executed, cause the first computing platform to instruct, with the virtual hardware abstraction layer, the second computing platform to one or more of configure the second hardware device, read data from the second hardware device, or write data to the second hardware device.

Example 5 includes the first computing platform of any one of Examples 1-4, wherein the instructions, when executed, cause the first computing platform to identify a request from a third computing platform to access the first hardware device, and in response to the request, grant access to the first hardware device based on one or more access permissions to allow the third computing platform to access the first hardware device.

Example 6 includes the first computing platform of Example 5, wherein the instructions, when executed, cause the first computing platform to monitor requests for actions from the third computing platform to identify whether the actions are permitted according to the one or more access permissions, wherein the actions are to be associated with the first hardware device, and deny one or more of the actions that are determined to be impermissible according to the one or more access permissions.

Example 7 includes a semiconductor apparatus comprising one or more substrates, and logic coupled to the one or more substrates, wherein the logic is implemented in one or more of configurable logic or fixed-functionality logic hardware, the logic coupled to the one or more substrates to identify a second computing platform that is to include a second hardware device that is to satisfy one or more conditions, wherein the second hardware device is to be associated with a hardware abstraction layer on the second computing platform, wherein the second computing platform is to be coupled to a first computing platform, and generate a virtual hardware abstraction layer that is to represent the hardware abstraction layer on the second computing platform.

Example 8 includes the semiconductor apparatus of Example 7, wherein the logic is to conduct an identification that a first hardware device of the first computing platform is to fail to satisfy the one or more conditions, wherein the one or more conditions are to include a functionality, in response to the identification, cause a query process to query a plurality of computing platforms to identify whether the plurality of computing platforms includes hardware devices that each satisfy the one or more conditions, wherein the plurality of computing platforms is to include the second computing platform, and identify the second hardware device based on responses by the plurality of computing platforms to the query process.

Example 9 includes the semiconductor apparatus of Example 7, wherein the logic is to cause, with the virtual hardware abstraction layer, the hardware abstraction layer associated with the second hardware device to execute one or more actions, wherein the one or more actions are to be associated with an application on the first computing platform.

Example 10 includes the semiconductor apparatus of Example 7, wherein the logic is to instruct, with the virtual hardware abstraction layer, the second computing platform to one or more of configure the second hardware device, read data from the second hardware device, or write data to the second hardware device.

Example 11 includes the semiconductor apparatus of any one of Examples 7-10, wherein the logic is to identify a request from a third computing platform to access a first hardware device of the first computing platform, and in response to the request, grant access to the first hardware device based on one or more access permissions to allow the third computing platform to access the first hardware device.

Example 12 includes the semiconductor apparatus of Example 11, wherein the logic is to monitor requests for actions from the third computing platform to identify whether the actions are permitted according to the one or more access permissions, wherein the actions are to be associated with the first hardware device, and deny one or more of the actions that are determined to be impermissible according to the one or more access permissions.

Example 13 includes the semiconductor apparatus of any one of Examples 7-10, wherein the logic coupled to the one or more substrates includes transistor channel regions that are positioned within the one or more substrates.

Example 14 includes at least one computer readable storage medium comprising a set of instructions, which when executed by a first computing platform, cause the first computing platform to identify a second computing platform that is to include a second hardware device that is to satisfy one or more conditions, wherein the second hardware device is to be associated with a hardware abstraction layer on the second computing platform, and generate a virtual hardware abstraction layer that is to represent the hardware abstraction layer on the second computing platform.

Example 15 includes the at least one computer readable storage medium of Example 14, wherein the instructions, when executed, cause the first computing platform to conduct an identification that a first hardware device of the first computing platform is to fail to satisfy the one or more conditions, wherein the one or more conditions are to include a functionality, in response to the identification, cause a query process to query a plurality of computing platforms to identify whether the plurality of computing platforms includes hardware devices that each satisfy the one or more conditions, wherein the plurality of computing platforms is to include the second computing platform, and identify the second hardware device based on responses by the plurality of computing platforms to the query process.

Example 16 includes the at least one computer readable storage medium of Example 14, wherein the instructions, when executed, cause the first computing platform to cause, with the virtual hardware abstraction layer, the hardware abstraction layer associated with the second hardware device to execute one or more actions, wherein the one or more actions are to be associated with an application on the first computing platform.

Example 17 includes the at least one computer readable storage medium of Example 14, wherein the instructions, when executed, cause the first computing platform to instruct, with the virtual hardware abstraction layer, the second computing platform to one or more of configure the second hardware device, read data from the second hardware device, or write data to the second hardware device.

Example 18 includes the at least one computer readable storage medium of any one of Examples 14-17, wherein the instructions, when executed, cause the first computing platform to identify a request from a third computing platform to access a first hardware device of the first computing platform, and in response to the request, grant access to the first hardware device based on one or more access permissions to allow the third computing platform to access the first hardware device.

Example 19 includes the at least one computer readable storage medium of Example 18, wherein the instructions, when executed, cause the first computing platform to monitor requests for actions from the third computing platform to identify whether the actions are permitted according to the one or more access permissions, wherein the actions are to be associated with the first hardware device, and deny one or more of the actions that are determined to be impermissible according to the one or more access permissions.

Example 20 includes a method of operating a first computing platform, the method comprising identifying a second computing platform that includes a second hardware device that satisfies one or more conditions, wherein the second hardware device is associated with a hardware abstraction layer on the second computing platform, wherein the second computing platform is coupled to the first computing platform, and generating a virtual hardware abstraction layer that represents the hardware abstraction layer on the second computing platform.

Example 21 includes the method of Example 20, further comprising conducting an identification that a first hardware device of the first computing platform fails to satisfy the one or more conditions, wherein the one or more conditions include a functionality, in response to the identification, causing a query process to query a plurality of computing platforms to identify whether the plurality of computing platforms includes hardware devices that each satisfy the one or more conditions, wherein the plurality of computing platforms is to include the second computing platform, and identifying the second hardware device based on responses by the plurality of computing platforms to the query process.

Example 22 includes the method of Example 20, further comprising causing, with the virtual hardware abstraction layer, the hardware abstraction layer associated with the second hardware device to execute one or more actions, wherein the one or more actions are to be associated with an application on the first computing platform.

Example 23 includes the method of Example 20, further comprising instructing, with the virtual hardware abstraction layer, the second computing platform to one or more of configure the second hardware device, read data from the second hardware device, or write data to the second hardware device.

Example 24 includes the method of any one of Examples 20-23, further comprising identifying a request from a third computing platform to access a first hardware device of the first computing platform, and in response to the request, granting access to the first hardware device based on one or more access permissions to allow the third computing platform to access the first hardware device.

Example 25 includes the method of Example 24, further comprising monitoring requests for actions from the third computing platform to identify whether the actions are permitted according to the one or more access permissions, wherein the actions are to be associated with the first hardware device, and denying one or more of the actions that are determined to be impermissible according to the one or more access permissions.

Example 26 includes a semiconductor apparatus comprising means for identifying a second computing platform that includes a second hardware device that is to satisfy one or more conditions, wherein the second hardware device is associated with a hardware abstraction layer on the second computing platform, wherein the second computing platform is coupled to a first computing platform, and means for generating a virtual hardware abstraction layer that is to represent the hardware abstraction layer on the second computing platform.

Example 27 includes the semiconductor apparatus of Example 26, wherein the semiconductor apparatus includes means for conducting an identification that a first hardware device of the first computing platform is to fail to satisfy the one or more conditions, wherein the one or more conditions are to include a functionality, means for in response to the identification, causing a query process to query a plurality of computing platforms to identify whether the plurality of computing platforms includes hardware devices that each is to satisfy the one or more conditions, wherein the plurality of computing platforms is to include the second computing platform, and means for identifying the second hardware device based on responses by the plurality of computing platforms to the query process.

Example 28 includes the semiconductor apparatus of Example 26, wherein the semiconductor apparatus includes means for causing, with the virtual hardware abstraction layer, the hardware abstraction layer associated with the second hardware device to execute one or more actions, wherein the one or more actions are to be associated with an application on the first computing platform.

Example 29 includes the semiconductor apparatus of Example 26, wherein the semiconductor apparatus includes means for instructing, with the virtual hardware abstraction layer, the second computing platform to one or more of configure the second hardware device, read data from the second hardware device, or write data to the second hardware device.

Example 30 includes the semiconductor apparatus of any one of Examples 26-29, wherein the semiconductor apparatus includes means for identifying a request from a third computing platform to access a first hardware device of the first computing platform, and means for in response to the request, granting access to the first hardware device based on one or more access permissions to allow the third computing platform to access the first hardware device.

Example 31 includes the semiconductor apparatus of Example 30, wherein the semiconductor apparatus includes means for monitoring requests for actions from the third computing platform to identify whether the actions are permitted according to the one or more access permissions, wherein the actions are to be associated with the first hardware device, and means for denying one or more of the actions that are determined to be impermissible according to the one or more access permissions.

Example 32 includes means for performing the method of any one of Examples 20-24.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A first computing platform comprising:
a first hardware device;
a graphics processor;
a central processing unit; and
a memory including a set of instructions, which when executed by one or more of the graphics processor or the central processing unit, cause the first computing platform to:
identify a second computing platform that is to include a second hardware device that is to satisfy one or more conditions, wherein the second hardware device is to be associated with a hardware abstraction layer on the second computing platform; and
generate a virtual hardware abstraction layer that is to represent the hardware abstraction layer on the second computing platform.

2. The first computing platform of claim 1, wherein the instructions, when executed, cause the first computing platform to:
conduct an identification that the first hardware device is to fail to satisfy the one or more conditions, wherein the one or more conditions are to include a functionality;
in response to the identification, cause a query process to query a plurality of computing platforms to identify whether the plurality of computing platforms includes hardware devices that each satisfy the one or more conditions, wherein the plurality of computing platforms is to include the second computing platform; and
identify the second hardware device based on responses by the plurality of computing platforms to the query process.

3. The first computing platform of claim 1, wherein the instructions, when executed, cause the first computing platform to:
cause, with the virtual hardware abstraction layer, the hardware abstraction layer associated with the second hardware device to execute one or more actions, wherein the one or more actions are to be associated with an application on the first computing platform.

4. The first computing platform of claim 1, wherein the instructions, when executed, cause the first computing platform to:
instruct, with the virtual hardware abstraction layer, the second computing platform to one or more of configure the second hardware device, read data from the second hardware device, or write data to the second hardware device.

5. The first computing platform of claim 1, wherein the instructions, when executed, cause the first computing platform to:
identify a request from a third computing platform to access the first hardware device; and
in response to the request, grant access to the first hardware device based on one or more access permissions to allow the third computing platform to access the first hardware device.

6. The first computing platform of claim 5, wherein the instructions, when executed, cause the first computing platform to:
monitor requests for actions from the third computing platform to identify whether the actions are permitted according to the one or more access permissions, wherein the actions are to be associated with the first hardware device; and
deny one or more of the actions that are determined to be impermissible according to the one or more access permissions.

7. A semiconductor apparatus comprising:
one or more substrates; and
logic coupled to the one or more substrates, wherein the logic is implemented in one or more of configurable logic or fixed-functionality logic hardware, the logic coupled to the one or more substrates to:
identify a second computing platform that is to include a second hardware device that is to satisfy one or more conditions, wherein the second hardware device is to be associated with a hardware abstraction layer on the second computing platform, wherein the second computing platform is to be coupled to a first computing platform; and
generate a virtual hardware abstraction layer that is to represent the hardware abstraction layer on the second computing platform.

8. The semiconductor apparatus of claim 7, wherein the logic is to:
conduct an identification that a first hardware device of the first computing platform is to fail to satisfy the one or more conditions, wherein the one or more conditions are to include a functionality;
in response to the identification, cause a query process to query a plurality of computing platforms to identify whether the plurality of computing platforms includes hardware devices that each satisfy the one or more conditions, wherein the plurality of computing platforms is to include the second computing platform; and
identify the second hardware device based on responses by the plurality of computing platforms to the query process.

9. The semiconductor apparatus of claim 7, wherein the logic is to:
cause, with the virtual hardware abstraction layer, the hardware abstraction layer associated with the second hardware device to execute one or more actions, wherein the one or more actions are to be associated with an application on the first computing platform.

10. The semiconductor apparatus of claim 7, wherein the logic is to:
instruct, with the virtual hardware abstraction layer, the second computing platform to one or more of configure the second hardware device, read data from the second hardware device, or write data to the second hardware device.

11. The semiconductor apparatus of claim 7, wherein the logic is to:
identify a request from a third computing platform to access a first hardware device of the first computing platform; and
in response to the request, grant access to the first hardware device based on one or more access permissions to allow the third computing platform to access the first hardware device.

12. The semiconductor apparatus of claim 11, wherein the logic is to:
monitor requests for actions from the third computing platform to identify whether the actions are permitted according to the one or more access permissions, wherein the actions are to be associated with the first hardware device; and
deny one or more of the actions that are determined to be impermissible according to the one or more access permissions.

13. The semiconductor apparatus of claim 7, wherein the logic coupled to the one or more substrates includes transistor channel regions that are positioned within the one or more substrates.

14. At least one computer readable storage medium comprising a set of instructions, which when executed by a first computing platform, cause the first computing platform to:
identify a second computing platform that is to include a second hardware device that is to satisfy one or more conditions, wherein the second hardware device is to be associated with a hardware abstraction layer on the second computing platform; and
generate a virtual hardware abstraction layer that is to represent the hardware abstraction layer on the second computing platform.

15. The at least one computer readable storage medium of claim 14, wherein the instructions, when executed, cause the first computing platform to:
conduct an identification that a first hardware device of the first computing platform is to fail to satisfy the one or more conditions, wherein the one or more conditions are to include a functionality;
in response to the identification, cause a query process to query a plurality of computing platforms to identify whether the plurality of computing platforms includes hardware devices that each satisfy the one or more conditions, wherein the plurality of computing platforms is to include the second computing platform; and
identify the second hardware device based on responses by the plurality of computing platforms to the query process.

16. The at least one computer readable storage medium of claim 14, wherein the instructions, when executed, cause the first computing platform to:
cause, with the virtual hardware abstraction layer, the hardware abstraction layer associated with the second hardware device to execute one or more actions, wherein the one or more actions are to be associated with an application on the first computing platform.

17. The at least one computer readable storage medium of claim 14, wherein the instructions, when executed, cause the first computing platform to:
instruct, with the virtual hardware abstraction layer, the second computing platform to one or more of configure the second hardware device, read data from the second hardware device, or write data to the second hardware device.

18. The at least one computer readable storage medium of claim 14, wherein the instructions, when executed, cause the first computing platform to:
identify a request from a third computing platform to access a first hardware device of the first computing platform; and
in response to the request, grant access to the first hardware device based on one or more access permissions to allow the third computing platform to access the first hardware device.

19. The at least one computer readable storage medium of claim 18, wherein the instructions, when executed, cause the first computing platform to:
monitor requests for actions from the third computing platform to identify whether the actions are permitted according to the one or more access permissions, wherein the actions are to be associated with the first hardware device; and
deny one or more of the actions that are determined to be impermissible according to the one or more access permissions.

20. A method of operating a first computing platform, the method comprising:
identifying a second computing platform that includes a second hardware device that satisfies one or more conditions, wherein the second hardware device is associated with a hardware abstraction layer on the second computing platform, wherein the second computing platform is coupled to the first computing platform; and
generating a virtual hardware abstraction layer that represents the hardware abstraction layer on the second computing platform.

21. The method of claim 20, further comprising:
conducting an identification that a first hardware device of the first computing platform fails to satisfy the one or more conditions, wherein the one or more conditions include a functionality;
in response to the identification, causing a query process to query a plurality of computing platforms to identify whether the plurality of computing platforms includes hardware devices that each satisfy the one or more conditions, wherein the plurality of computing platforms is to include the second computing platform; and
identifying the second hardware device based on responses by the plurality of computing platforms to the query process.

22. The method of claim 20, further comprising:
causing, with the virtual hardware abstraction layer, the hardware abstraction layer associated with the second hardware device to execute one or more actions, wherein the one or more actions are to be associated with an application on the first computing platform.

23. The method of claim 20, further comprising:
instructing, with the virtual hardware abstraction layer, the second computing platform to one or more of configure the second hardware device, read data from the second hardware device, or write data to the second hardware device.

24. The method of claim 20, further comprising:
identifying a request from a third computing platform to access a first hardware device of the first computing platform; and
in response to the request, granting access to the first hardware device based on one or more access permissions to allow the third computing platform to access the first hardware device.

25. The method of claim 24, further comprising:
monitoring requests for actions from the third computing platform to identify whether the actions are permitted according to the one or more access permissions, wherein the actions are to be associated with the first hardware device; and
denying one or more of the actions that are determined to be impermissible according to the one or more access permissions.
